(19) United States
(12) Patent Application Publication
(10) Pub. No.: US 2026/0058495 A1
(43) Pub. Date: Feb. 26, 2026

(54) SYSTEM AND METHOD FOR WIRELESS POWER TRANSFER

(71) Applicant: Solace Power Inc., Mount Pearl (CA)

(72) Inventors: Samuel Robert COVE, Paradise (CA); Dominic JEYAMANOHARAN, St. John's (CA); Jean-Robert DESROSIERS, Spaniard's Bay (CA); Christopher Thomas SEARY, Mount Pearl (CA); Jonathan DAWE, Paradise (CA); Rasool KAHANI, St. John's (CA); Amir TAHAVORGAR, Melrose, MA (US); Reza HESARAKI, Montreal (CA)

(73) Assignee: Solace Power Inc., Mount Pearl, NL (CA)

(21) Appl. No.: 19/304,844

(22) Filed: Aug. 20, 2025

Related U.S. Application Data
(60) Provisional application No. 63/685,112, filed on Aug. 20, 2024.

(51) Int. Cl. H02J 50/12; H02J 50/40

(52) U.S. Cl. CPC H02J 50/12; H02J 50/402

(57) ABSTRACT

System and method for wireless power transfer. The system comprises a plurality of wireless transmitters, connectable to a power source; a plurality of wireless receivers wherein each of the wireless receivers is configured to transiently receive power from at least one of the plurality of wireless transmitters when proximate thereto; and a plurality of voltage regulators, each voltage regulator electrically connected to at least one of the plurality of wireless receivers.

### CROSS-REFERENCE TO RELATED APPLICATIONS

This application claims the benefit of U.S. Provisional Application No. 63/685,112 filed Aug. 20, 2024, the content of which is incorporated by reference in its entirety.

### TECHNICAL FIELD

This application relates a system and method for wireless power transfer.

### BACKGROUND

Supplying electrical energy has progressed from the traditional method of supplying electrical energy through wired connections, to contactless delivery via wireless power transfer. Wireless power transfer refers to various technologies for transmitting energy by means of electric or magnetic fields. The power received by a wireless receiver can be used in a number of applications including charging batteries, or directly powering loads. Wireless power transfer systems can be utilized in both stationary applications and in moveable applications.

### SUMMARY

The following summary is intended to introduce the reader to various aspects of the detailed description, but not to define or delimit any invention.

In at least one broad aspect, there is provided a system for wireless power transfer comprising: a plurality of wireless transmitters, connectable to a power source; a plurality of wireless receivers wherein each of the wireless receivers is configured to transiently receive power from at least one of the plurality of wireless transmitters when proximate thereto; and a plurality of voltage regulators, each voltage regulator electrically connected to at least one of the plurality of wireless receivers.

In some cases, each voltage regulator is a DC to DC converter.

In some cases, each voltage regulator is electrically connected to a respective wireless receiver of the plurality of wireless receivers.

In some cases, each voltage regulator is electrically connected to two or more wireless receivers of the plurality of wireless receivers, wherein each wireless receiver of the two or more wireless receivers are non-adjacent.

In some cases, each voltage regulator is electrically connected to a balancing resistor.

In some cases, the balancing resistor is a resistor in series with each voltage regulator.

In some cases, the balancing resistor is a variable resistor controllable to optimize voltage across each voltage regulator.

In some cases, each wireless receiver of the plurality of wireless receivers comprises a coil and a rectifier, respectively.

In some cases, each coil includes a tuning capacitor.

In some cases, the system further comprises an input conditioner electrically connected to each of the plurality of wireless transmitters and configured to energize each wireless transmitter simultaneously.

In some cases, the system is a rotary system, wherein the plurality of wireless receivers is arranged in a stator of the rotary system, and wherein the plurality of wireless transmitters is arranged in a rotor of the rotary system.

In some cases, the system is a rotary system, wherein the plurality of wireless receivers is arranged in a rotor of the rotary system, and wherein the plurality of wireless transmitters is arranged in a stator of the rotary system.

In some cases, the plurality of wireless transmitters is arranged equidistant from each other about the stator.

In some cases, the plurality of wireless receivers is arranged equidistant from each other around about the rotor.

In some cases, the system further comprises a housing enclosing the stator and the rotor, wherein the housing is generally circular and has a first annular portion that is stationary and another portion that is rotatable relative to the first annular portion.

In some cases, each wireless receiver receives power from a respective wireless transmitter when there is an overlap between each wireless receiver and the respective wireless transmitter.

In some cases, the plurality of wireless receivers includes at least four wireless receivers.

In some cases, the plurality of wireless receivers includes at least two wireless transmitters.

In some cases, a ratio of the plurality of wireless receivers to the plurality of wireless transmitters is at least 3:2.

In another broad aspect, there is provided a method of wireless power transfer comprising: arranging a plurality of wireless receivers proximate to a plurality of wireless transmitters; translating the plurality of wireless receivers relative to the plurality of wireless transmitters; transferring power from at least one of the plurality of wireless transmitters to at least one of the plurality of wireless receivers; and regulating an output of each wireless receiver with a plurality of voltage regulators, each voltage regulator electrically connected to at least one of the plurality of wireless receivers.

In some cases, each voltage regulator is a DC to DC converter.

In some cases, the arranging the plurality of wireless receivers proximate to the plurality of wireless transmitters comprises electrically connecting each voltage regulator to a respective wireless receiver of the plurality of wireless receivers.

In some cases, the arranging the plurality of wireless receivers proximate to the plurality of wireless transmitters comprises electrically connecting each voltage regulator to two or more wireless receivers of the plurality of wireless receivers, wherein each wireless receiver of the two or more wireless receivers are non-adjacent.

In some cases, the arranging the plurality of wireless receivers proximate to the plurality of wireless transmitters comprises electrically connecting each voltage regulator to a balancing resistor.

In some cases, the balancing resistor is a resistor in series with each voltage regulator.

In some cases, the method further comprises optimizing a voltage across each voltage regulator with a variable resistor.

In some cases, each wireless receiver of the plurality of wireless receivers comprises a coil and a rectifier, respectively.

In some cases, each coil includes a tuning capacitor.

In some cases, the method further comprises energizing each of the plurality of wireless transmitters simultaneously with a respective input conditioner electrically connected to each of the plurality of wireless transmitters.

In some cases, the method further comprises limiting the current through each voltage regulator to equalize a voltage across each voltage regulator.

In some cases, the plurality of wireless receivers is arranged in a stator of a rotary system, and wherein the plurality of wireless transmitters is arranged in a rotor of the rotary system.

In some cases, the plurality of wireless receivers is arranged in a rotor of a rotary system, and wherein the plurality of wireless transmitters is arranged in a stator of the rotary system.

In some cases, the arranging the plurality of wireless receivers proximate to the plurality of wireless transmitters comprises arranging, the plurality of wireless transmitters equidistant from each other about the stator.

In some cases, the arranging the plurality of wireless receivers proximate to the plurality of wireless transmitters further comprises arranging the plurality of wireless receivers equidistant from each other about the rotor.

In some cases, a housing encompasses the stator and the rotor, wherein the housing is generally circular and has a first annular portion that is stationary and another portion that is rotatable relative to the first annular portion.

In some cases, the transferring power from at least one of the plurality of wireless transmitters to at least one of the plurality of wireless receivers comprises overlapping each wireless receiver and a respective wireless transmitter.

In some cases, the plurality of wireless receivers includes at least four wireless receivers.

In some cases, the plurality of wireless receivers includes at least two wireless transmitters.

In some cases, a ratio of the plurality of wireless receivers to the plurality of wireless transmitters is at least 3:2.

According to some aspects, the present disclosure provides an aircraft comprising any of the systems described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 illustrates an exemplary housing for a wireless power transfer system;

FIG. 2 illustrates a portion of the exemplary housing of FIG. 1;

FIG. 3 illustrates another portion of the exemplary housing of FIG. 1;

FIG. 4 illustrates an exemplary wireless power transfer system;

FIG. 5 illustrates another exemplary wireless power transfer system;

FIG. 6 illustrates a portion of the exemplary wireless power transfer system of FIG. 5;

FIG. 7 illustrates operational results of the exemplary wireless power transfer system of FIG. 5;

FIG. 8 illustrates another exemplary wireless power transfer system;

FIG. 9 illustrates yet another exemplary wireless power transfer system;

FIG. 10 is a block diagram of an exemplary method of wireless power transfer.

### DETAILED DESCRIPTION

Wireless power systems can have one or multiple transmitters and multiple receivers powering a device or devices on the receiver side. In applications where the receivers are movable with respect to the transmitters, motion in the system causes the receivers to cycle through the one or more transmitters over time. If multiple transmitters are used, there can be times during the cycling of receivers in which a subset of the receivers is fully aligned with a subset of transmitters, while another subset of the receivers is misaligned with another subset of the transmitters. This alignment and misalignment of receivers with transmitters varies periodically throughout the full range of motion of the receivers (or transmitters if it is the transmitters that are moveable with respect to the receivers). In some cases, the alignment and misalignment of the receivers is dependent on the number of transmitters and the angle between the multiple transmitters. There are a variety of system architectures that could be used for this purpose.

In the following, a system for wireless power transfer is described. The system comprises a plurality of wireless transmitters that are connectable to a power source, and a plurality of wireless receivers. Each of the wireless receivers is configured to transiently receive power from at least one of the plurality of wireless transmitters when proximate thereto, and a plurality of voltage regulators are electrically connected to at least one of the plurality of wireless receivers to regulate the output thereof.

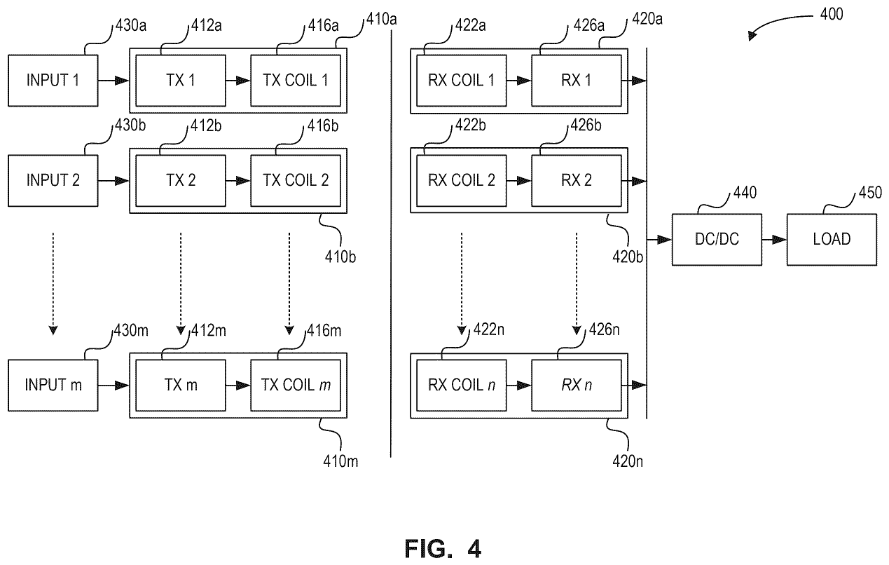

Referring first to FIG. 4, an example architecture of a system for wireless power transfer is shown. The system is generally identified by reference character 400. The system 400 includes one or more transmitting assembly 410a-410m and one or more receiving assembly 420a-420n. Each transmitting assembly 410a-410m includes a transmitter inverter 412a-412m and a transmitter coil 416a-416m. An input 430a-430m is connected to an input of a respective transmitting assembly 410a-410m and, in particular, to an input of a respective transmitter inverter 412a-412m. The output of each transmitter inverter 412a-412m is connected to an input of a respective transmitter coil 416a-416m, which generates a corresponding magnetic field (or, in some embodiments, electric field). For instance, the first transmitter inverter 412a is connected to the first transmitter coil 416a, the second transmitter inverter 412b is connected to the second transmitter coil 416b, and, if m>2, the m^{th} transmitter inverter 412m is connected to the m^{th} transmitter coil 416m.

Each receiving assembly 420a-420n includes a receiver coil 422a-422n and a receiver rectifier 426a-426n. The receiver coils 422a-422n of the receiving assemblies 420a-420n are spaced apart from the transmitter coils 416a-416m of the transmitting assemblies 410a-410m. For example, the transmitter coils 416a-416m and receiver coils 422a-422n may be spaced apart by an air gap to prevent electrical conduction. However, the spacing is such that the receiver coils 422a-422n are coupled to the transmitter coils 416a-416m by their electric fields (or, in some embodiments, by their magnetic fields). The output of each receiver coil 422a-422n is connected to an input of a respective receiver rectifier 426a-426n. In this example, a single voltage regulator 440 regulates the outputs of the receiver rectifiers 426a-426n and supplies a load 450. In this example, the voltage regulator 440 is a DC-to-DC converter.

Although the system 400 in FIG. 4 shows a plurality of transmitting assemblies 410a-410m, other arrangements are possible. In some cases, there may be only one transmitting assembly 410a. In some cases, there may be two transmitting assemblies 410a, 410b. In some cases, there may be more than two transmitting assemblies 410a-410m. Similarly, there may be any number of receiving assemblies 420a-420n. In some cases, there may be the same number of receiving assemblies 420a-420n as transmitting assemblies 410a-410m. In some cases, the number n of receiving assemblies 420a-420n is greater than or equal to the number m of transmitting assemblies 410a-410m, such that n>m. For example, there may be a ratio of transmitting assemblies 410a-410m to receiving assemblies 420a-420m, such as 1:2, 2:3, 1:3, 1:4, etc. In some cases, there may be fewer receiving assemblies 420a-420m than transmitting assemblies 410a-410m.

In the system 400, one receiver rectifier 426a-426n is paired with each receiver coil 422a-422n, with the outputs of all the receiver rectifiers 426a-426n tied together and fed into the single voltage regulator 440, i.e., the output DC-to-DC converter, which powers the load 450. In this configuration, power will only transfer to the voltage regulator 440 from the receiver rectifier 426a-426n with the highest instantaneous output voltage. As a result, the rectified output voltage can swing widely based on the degree of electric field coupling between the transmitters and receivers. As an example, the rectified output voltage could swing between 0 V and 140 V under full coupling. In this case, the full power would transmit through a wireless link that is not fully coupled, which results in the rectified voltage dropping quickly. The diode current on the receiver rectifier increases as a result and leads to heating, which can eventually cause thermal protection (not shown) to trip.

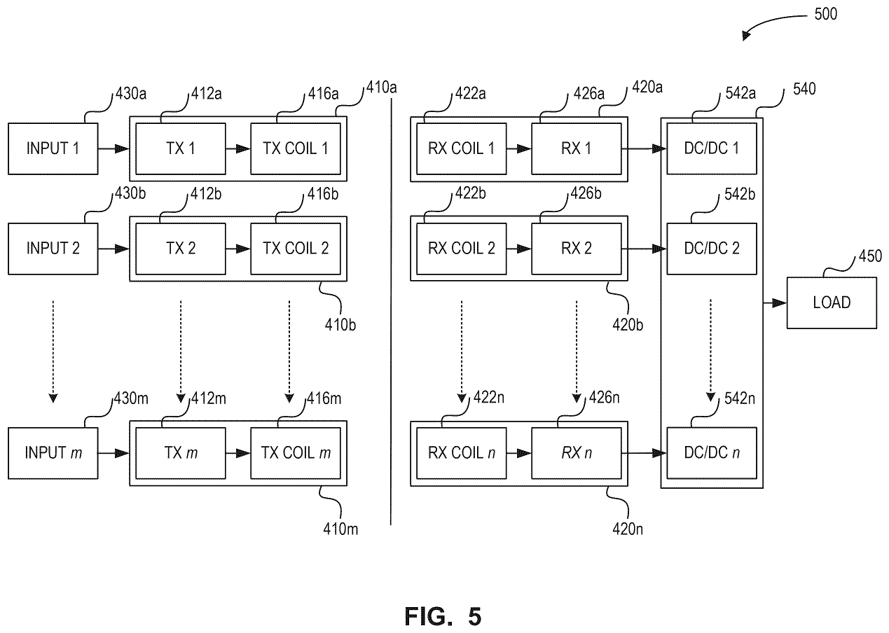

One approach to addressing the above-mentioned voltage swing is to introduce multiple voltage regulators. Referring now to FIG. 5, another example system for wireless power transfer is shown in accordance with at least some embodiments. The system is generally identified by reference character 500. The system 500 is generally similar to system 400, but includes a voltage regulator assembly 540 in place of the single voltage regulator 440. As in system 400, the system 500 includes the inputs 430a-430m, transmitting assemblies 410a-410m, and receiving assemblies 420a-420n. However, in contrast to system 400, the output of each receiver rectifier 426a-426n is input to the voltage regulator assembly 540. The voltage regulator assembly 540 includes a plurality of voltage regulators 542a-542n, which regulate the outputs of the receiver rectifiers 426a-426n and supply the load 450. In particular, the output of each receiver rectifier 426a-426n connects to a respective voltage regulator 542a-542n of the voltage regulator assembly 540. In this example, the voltage regulators 542a-542n are DC-to-DC converters.

Incorporating a separate voltage regulator 542a-542n for each receiver rectifier 426a-426n, and combining the voltage regulator 542a-542n outputs to power the load 450 reduces large voltage swings in the rectified voltage as the receiver rectifiers 426a-426n are now load sharing when they previously would not have been. Moreover, the regulated output voltage of the voltage regulators 542a-542n allows power to be shared independently of the coupling between transmitter and receiver. Load can be shared at any percentage based on the coupling between the transmitter coils 416a-416m and receiver coils 422a-422n. This also allows multiple transmitters to be used simultaneously in system 500 and to contribute power to the load 450 simultaneously.

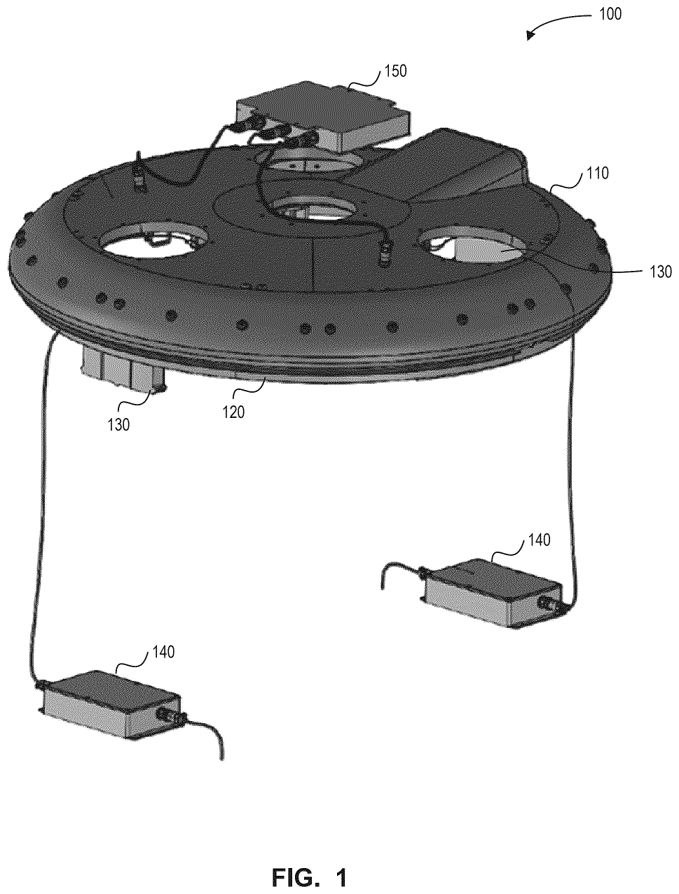

Referring now to FIG. 1, a perspective view of an example housing for a wireless power transfer system is shown. The housing is generally identified by reference character 100. In this example, the housing 100 is a rain shield for an aircraft and, in particular, a rotary wing aircraft. The housing 100 is generally provided on an exterior portion of a main body of the aircraft, such as around the rotor mast of a helicopter. For instance, the housing 100 generally surrounds a rotor assembly of the aircraft and is configured to prevent ingress of water or other contaminants into the rotor assembly.

The housing 100 includes a rotor portion 110 and a stator portion 120. Exemplary components of a wireless power transfer system are shown with respect to the housing 100. At least two wireless transmitter assemblies 130 are provided on the stator portion 120 of the housing 100. An input conditioner 140 is electrically connected to each of the at least two wireless transmitter assemblies 130. A voltage regulator 150 is coupled to the rotor portion 110 of the housing 100. The voltage regulator 150 may be, for example, a DC-to-DC converter.

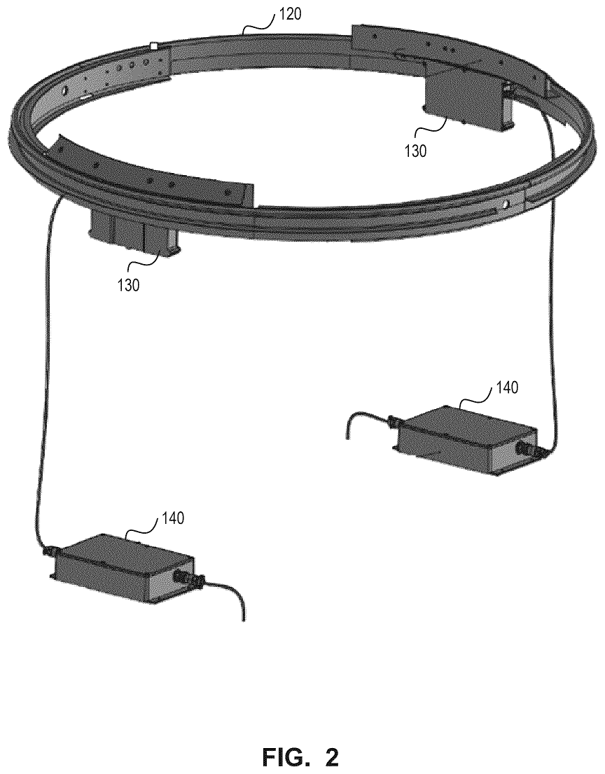

Referring now to FIG. 2, a perspective view of only the stator portion 120 of the housing 100 is shown. The stator portion 120 of the housing 100 is generally annular and is fixed to the main body of the vehicle. The stator portion 120 may also include a track, rail or other guide to facilitate or constrain rotation of the rotor portion 110 about the stator portion 120. In this example, the at least two wireless transmitter assemblies 130 are spaced apart by an angular distance of about 180°, i.e., they are opposing each other. The at least two wireless transmitter assemblies 130 are provided on an inner peripheral surface of the stator portion 120 of the housing 100.

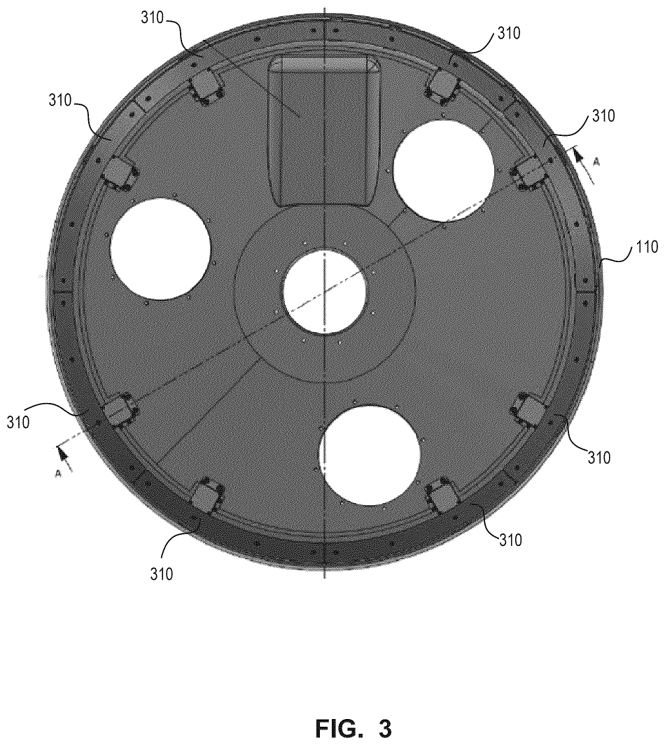

Referring now to FIG. 3, a bottom view of only the rotor portion 110 of the housing 100 is shown. The rotor portion 110 of the housing 100 is generally annular 120 and is fixed to a rotational element of the vehicle, such as the rotor shaft (not shown), which may pass through a central aperture of the rotor portion 110. A plurality of receiver assemblies 310 are provided on an inner peripheral surface of the rotor portion 110 of the housing 100. The plurality of receiver assemblies 310 are uniformly sized, arcuate shaped, elongated casings positioned around the perimeter of the rotor portion 110. In the example shown, there are 8 receiver assemblies and the casings are sized such that they occupy an equal proportion of the perimeter (i.e. ⅛^{th} of the perimeter). In some cases, the plurality of receiver assemblies 310 may be smaller and spaced apart. For example, the plurality of receiver assemblies may be at alternating intervals of 30° and 60° or, put another way, pairs of receiver assemblies may be spaced apart by 90°, which each of the receiver assemblies forming each pair being spaced 30° apart. In other embodiments, the spacing may be equidistant (e.g., if six receivers are used, all receivers may be 60° apart).

The rotor portion 110 is configured so that it is rotatably movable with respect to the stator portion 120. In particular, the rotor portion 110 rotates together with the rotor shaft, which causes the plurality of receiver assemblies 310 to rotate with respect to the at least two transmitter assemblies 130. In some cases, the at least two transmitter assemblies 130 are movable with respect to the plurality of receiver assemblies 310 (i.e., the transmitter assemblies 130 may be provided on the rotor portion 110 and the receiver assemblies 310 may be provided on the stator portion 120).

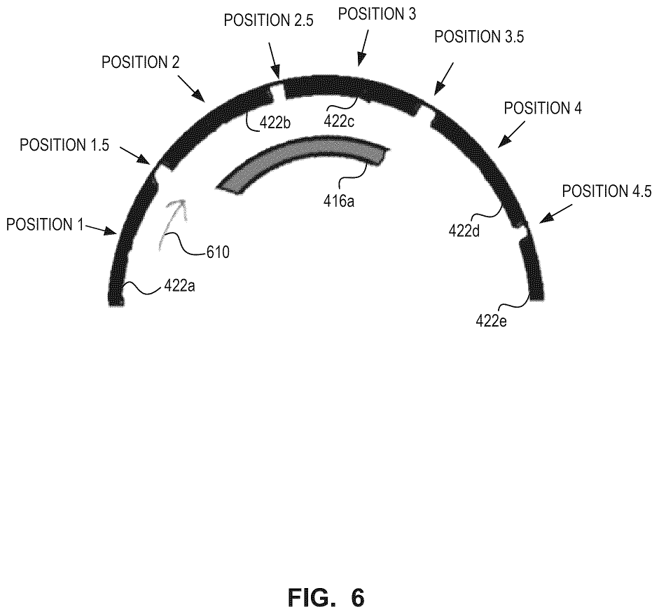

Referring now to FIG. 6, there is shown an example arrangement of receiver coils 422a-422e with respect to the first transmitter coil 416a of system 400 and system 500. For ease of illustration, only the first transmitter coil 416a is shown but it will be understood that similar principles apply to the second transmitter coil 416b or any additional transmitter coils e.g. up to and including the m^{th} transmitter coil 416m. Likewise, only receiver coils 422a-422e are shown, but it will be understood that additional receiver coils may be provided, e.g., to complete a full circle.

Each receiver coil 422a-422e conforms to, and is arranged in, an arc proximate to the first transmitter coil 416a. The receiver coils 422a-422e and the first transmitter coil 416a are spaced apart radially. The conformal arcuate shape of each receiver coil 422a-422e assists in maintaining uniform radial spacing between each receiver coil and a transmitter coil as the receiver coils rotate about the transmitter coil (or vice versa). In an example, the distance between the receiver coils 422a-422e and the first transmitter coil 416a is between about 0.5 inches and about 1 inch. Preferably the distance is about 0.75 inches.

The receiver coils 422a-422e are rotatably moveable with respect to the first transmitter coil 416a in a radial direction 610. As the receiver coils 422a-422e rotate in direction 610, the first transmitter coil 416a remains stationary. As the receiver coils 422a-422e rotate, each receiver coil 422a-422e overlaps with the first transmitter coil 416a in turn. Depending on the arc lengths of the receiver coils and the transmitter coils, multiple receiver coils may overlap portions of the transmitter coil at any given time. For example, when the rotation of the receiver coils 422a-422e causes a midpoint of transmitter coil 416a to align with position 2.5, then the electric field of transmitter coil 416a may be coupled with both receiver coils 422b and 422c. Similarly, when the rotation of the receiver coils 422a-422e causes a midpoint of transmitter coil 416a to align with position 2, then the electric field of transmitter coil 416a may be strongly coupled with receiver coil 422b, and may also be weakly coupled with receiver coils 422a and 422c.

Generally, power is transferred from the first transmitter coil 416a to the respective overlapping receiver coil 422a-422e when there is sufficient overlap. For instance, for power transfer to begin, the overlap between the respective receiver coil 422a-422e and the first transmitter coil 416 may be between 20 and 30%. For example, in some cases this degree of overlap corresponds to a voltage of about 12 V. When the first transmitter coil 416a and a respective receiver coil 422a-422e are maximally aligned, the voltage regulator, such as voltage regulator 542a, is in a boost mode. When the first transmitter coil 416a and the respective receiver coil 422a-422e are less than maximally aligned, the voltage regulator 542a is in a buck mode.

FIG. 6 illustrates several positions on the rotor portion 110 of the housing 100 with respect to the center of the first transmitter coil 416a. For example, position 1 is when the center of receiver coil 422a is fully aligned with the center of the first transmitter coil 416a. Position 1.5 is when the midpoint between receiver coil 422a and receiver coil 422b is aligned with the center of the first transmitter coil 416a. Position 2 is when the center of receiver coil 422b is fully aligned with the center of the first transmitter coil 416a. Position 2.5 is when the midpoint between receiver coil 422b and receiver coil 422c is aligned with the center of the first transmitter coil 416. Position 3 is when the center of receiver coil 422c is fully aligned with the center of the first transmitter coil 416. Position 3.5 is when the midpoint between receiver coil 422c and receiver coil 422d is aligned with the center of the first transmitter coil 416. Position 4 is when the center of receiver coil 422d is fully aligned with the center of the first transmitter coil 416. Position 1.5 is when the midpoint between receiver coil 422d and receiver coil 422e is aligned with the center of the first transmitter coil 416. Although the positions are described in relation to the first transmitter coil 416a, a similar arrangement applies with respect to the centre of the second transmitter coil 418a.

Although the arrangement is FIG. 6 describes the receiver coils 422a-422e as being moveable with respect to the first transmitter coil 416a (and the second transmitter coil 416b) other arrangements are possible. In some cases, the receiver coils 422a-422e may be stationary and the first and second transmitter coils 416a, 416b are moveable with respect to them.

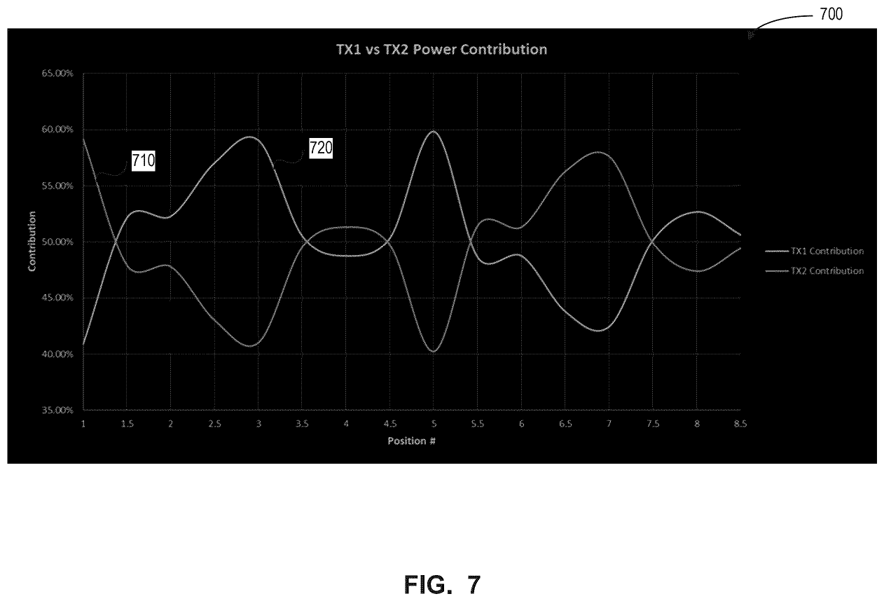

Referring now to FIG. 7, a power contribution graph 700 is shown for the system 500. The graph 700 shows the power transfer contribution from a first transmitter coil 416a and a second transmitter coil 416b when the first and second transmitter coils are sharing the load. The power transfer contribution is shown as a percentage. Trace 710 represents the contribution of the first transmitter coil 416a. Trace 720 represents the contribution of the of the second transmitter coil 416b. The percentage contribution is based on the input current of each transmitter coil. As the receiver coils 422a-422e move with respect to the first transmitter coil 416a and the second transmitter coil 416b, the percentage contribution of each transmitter coil varies.

In some cases, there may be upper and lower limits to the speed at which a transmitter assembly, such as transmitter assembly 410a of system 500, can translate between two adjacent receivers. To account for this, the voltage regulators 542a-542n may enforce a finite turn-on and turn-off time in the order of tens of milliseconds. The turn-on and turn-off times (also called “soft-start” and “soft-stop” times, respectively) can be adjusted through the soft-start and soft-stop features of the particular voltage regulator 542a-542n controller. A lower soft-start time may be favored for high speed rotation applications, such as that of the rotor assembly, but may cause significant current spikes being drawn from the transmit side of the system 500 as the speed increases. This is due to the fast charging of tuning capacitors (not shown) on the receive side. Slowing the rate at which these tuning capacitors are charged reduces the spikes but causes drops in the output voltage under fast rotation. Also, the repeated turning on and off of the voltage regulators 542a-542n can stress the capacitors. In some cases, a soft-start circuit may be used to smooth the transitions, but this may trade speed for stability. Generally, the circuit and the tuning capacitors are sized to handle the highest speed expected to be seen in the system (e.g., 300 rpm). In an example, the tuning capacitors may have a capacity of about 60 pF. Generally, the system 500 is sensitive to the efficiency of all receive side subsystems. Whichever is more efficient will draw more power from the transmit side, which can cause imbalances at the input of the system 500.

Current sharing across the voltage regulators 542a-542n may be improved in some embodiments, as described further herein. As an example of their operation, consider when the system 500 includes four receiver coils 422a-422n (i.e., when n=4), each connected to a receiver rectifier 426a-426n, and each receiver rectifier 426a-426n connected to a voltage regulator 542a-542n. In this example, the voltage regulators 542a-542n are identified as DC/DC 1, DC/DC 2, DC/DC 3, and DC/DC 4 in order from highest to lowest output voltage. The DC/DC with the highest output voltage (DC/DC 1) would be the first voltage regulator, e.g., first voltage regulator 542a, to draw power. This causes its output voltage to sag, until it is lower than DC/DC 2. Current then goes through DC/DC 2 until its output voltage is either below DC/DC 1 again, or below DC/DC 3. Once both DC/DC 1 and DC/DC 2 have an output voltage below DC/DC 3, DC/DC 3 starts to conduct. Once DC/DC 1 through DC/DC 3 have an output voltage below DC/DC 4, all the receivers are conducting. Once all the load power has been drawn from the circuit, all four output voltages from DC/DC 1 through DC/DC 4 will be at the same output voltage but will contribute different amounts of current to the load, proportional to their unloaded output voltages.

One technique to refine the current sharing across the voltage regulators 542a-542n is to introduce a current limit to each voltage regulator 542a-542n which is less than the total load current. This clamps the contribution of each voltage regulator 542a-542n to a value which is acceptable for system operation. For example, each voltage regulator 542a-542n may be clamped to a 3 A output for a 4 A load so that they would never contribute more than 75% of the load at any given time. However, with the 3 A limit, when a transmitter coil 416a-416m and a receiver coil 422a-422n are fully aligned, once the voltage regulator 542a-542n clamps the output current, transmitter side protection may not detect an overload condition. This is because each transmitter assembly 410a-410m is sized to handle current spikes to 3 A caused during rotation (these are caused due to the soft start of the voltage regulator 542a-542n). Increasing the current limit may further worsen the load sharing.

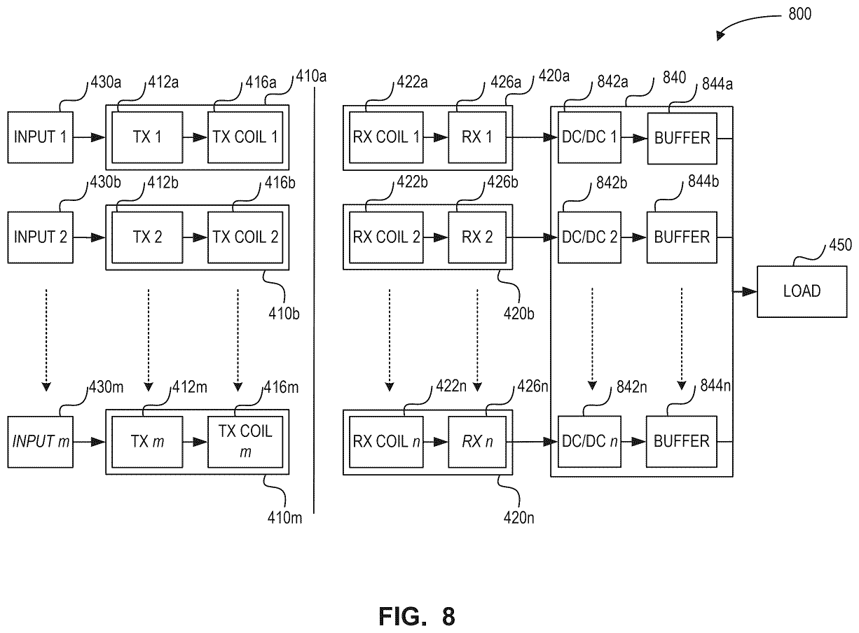

Another technique to equalize the voltages is to include a balancing resistor in series between the output of each voltage regulator 542a-542n and the load 450. Referring now to FIG. 8, there is illustrated another system for wireless power transfer, generally identified by reference character 800. The system 800 is generally similar to system 500, but includes a voltage regulator assembly 840 that includes a plurality of voltage regulators 842a-842n with the output of each voltage regulator 842a-842n connected to a respective balancing resistor 844a-844n.

As in system 500, the output of each receiver rectifier 426a-426n connects to a respective voltage regulator 842a-842n in the voltage regulator assembly 840. In this example, the voltage regulators 842a-842n are DC-to-DC converters. The output of each voltage regulator 842a-842n is connected to a respective balancing resistor 844a-844n. The balancing resistor 844a-844n in this is example is a resistor connected in series with each voltage regulator 842a-842n and the load 450. In an example, each resistor has a resistance in the order of 10s of mΩ. In some cases, each resistor has a resistance that is less than 50 mΩ, and preferably between 10 and 50 mΩ.

Adding the balancing resistor 844a-844n mimics a simple feedback loop that controls the current through each voltage regulator 842a-842n. In the previous current sharing example, consider DC/DC 1 (e.g. voltage regulator 542a) that had the higher voltage among the four voltage regulators. Due to the higher voltage, this would draw more current and contribute more to the load 450. By adding the balancing resistor, e.g. balancing resistor 844a, in series between the voltage regulator 842a output and the overall output from the voltage regulator assembly 840, the voltage drop across the balancing resistor 844a for DC/DC 1 is higher under load, causing its output voltage to sag more. By making this voltage low, another voltage regulator, DC/DC 2 (e.g. voltage regulator 842b), achieves the higher voltage and starts contributing more to the load 450. Then its voltage will start to sag until DC/DC 3 is higher. This process continues until a steady state is reached and whereby the current sharing is improved. However, as there is a drop in efficiency, the size of the balancing resistor should be kept low for optimal performance.

Although the system 800 is described as having a series resistor with a resistance less than 50 mΩ as the balancing resistor 844a-844n, other arrangements are possible. In some cases, the balancing resistor 844a-844n may be a variable resistor controllable to optimize to the voltage across the voltage regulators 842a-842n.

Another approach is to reduce the number of voltage regulators such that one voltage regulator connects to multiple, non-adjacent receiver rectifiers which are guaranteed to not receive power simultaneously. For example, two non-adjacent wireless receivers are separated by at least one other wireless receiver.

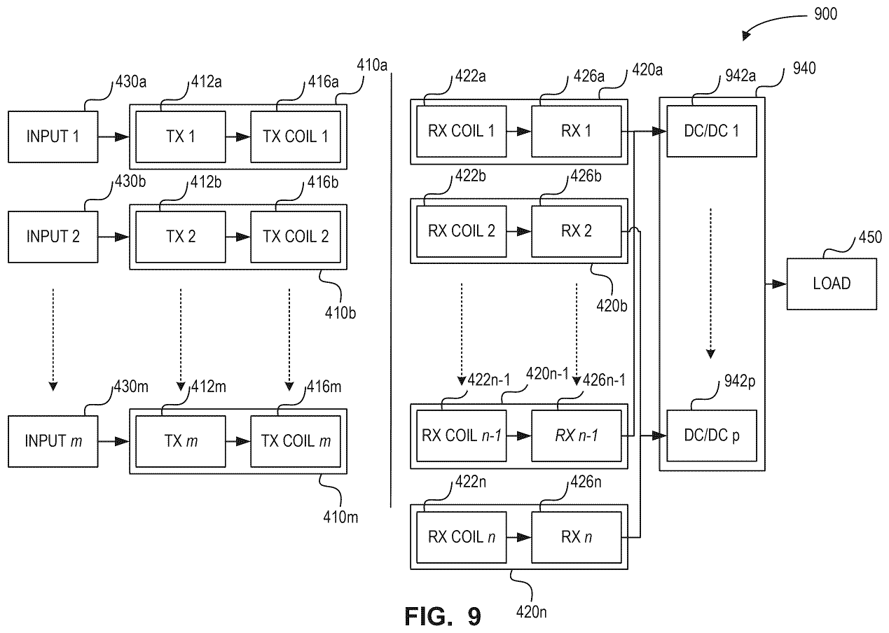

Referring now to FIG. 9 a system for wireless power transfer is shown. The system is generally identified by reference character 900. The system 900 is generally similar to system 500, but includes a voltage regulator assembly 940 that includes a plurality of voltage regulators 942a-942p where each voltage regulator 942a-942p connects to more than one non-adjacent receiver rectifier 426a-426n. Although not shown, system 900 may also incorporate the balancing resistors of system 800 in some embodiments.

As in system 500, the output of each receiver rectifier 426a-426n connects to the voltage regulator assembly 940. The voltage regulator assembly 940 includes the plurality of voltage regulators 942a-942p. In system 900, however, the outputs of non-adjacent receiver rectifiers connect to a respective, shared voltage regulator. For example, receiver rectifiers 426a, 426n-1, connect to voltage regulator 942a in the voltage regulator assembly 940. Receiver rectifiers 426b, 426n, connect to voltage regulator 942b in the voltage regulator assembly 940. In this example, the voltage regulators 942a-942p are DC-to-DC converters. The output of each voltage regulator 942a-942p is connected to the load 450.

In system 900 as shown in FIG. 9, the number of rectifiers, n, is twice the number of voltage regulators, p. Accordingly, FIG. 9 shows two non-adjacent receiver rectifiers 426a and 426n-1 connecting to a single voltage regulator 942a. However, other arrangements are possible. In some cases, more than two non-adjacent receiver rectifiers 426a-426n may connect to a single voltage regulator 942a-942p.

This arrangement, in which receiver rectifiers share voltage regulators, minimizes the size and weight of the system. The voltage regulators 942a-942p generally are designed such that their output voltage does not vary with their input voltage. However, output voltage may vary due to changes in operating mode (boost, buck, or buck-boost) or changes from compensation networks based on input voltage. The issue of operating mode can be mitigated, e.g., by shifting the arrangement of the transmitters. For example, in a two transmitter arrangement, the angular spacing may be shifted from 180° to 155°, thus ensuring any voltage regulators 942a-942p would be in the same mode of operation at any given time.

The described systems 400, 500, 800, 900 can synchronize the energization of the first transmitter coil 416a and the second transmitter coil 416b. The input conditioners 130 are used to achieve this. An input conditioner 130 is connected to each of the first transmitter inverter 412a and the second transmitter inverter 412b. When the system 400, 500, 800, 900 is switched on, and the load 450 is on, typically one of the transmitters will turn on faster and supply the full load for a small window. This can result in fault conditions. The input conditioners 130 include software that detects the startup condition. The input conditioners 130 supply the voltage initially to each of the first transmitter inverter 412a and the second transmitter inverter 412b. This allows both of the transmitters to energize almost simultaneously. There may be a negligible difference in time between energization, such as 2 ms.

In systems where there are more than two transmitter assemblies 410a-410m, having an input conditioner 130 for each transmitter assembly 410a-410m will enable the synchronized energization of the transmitters.

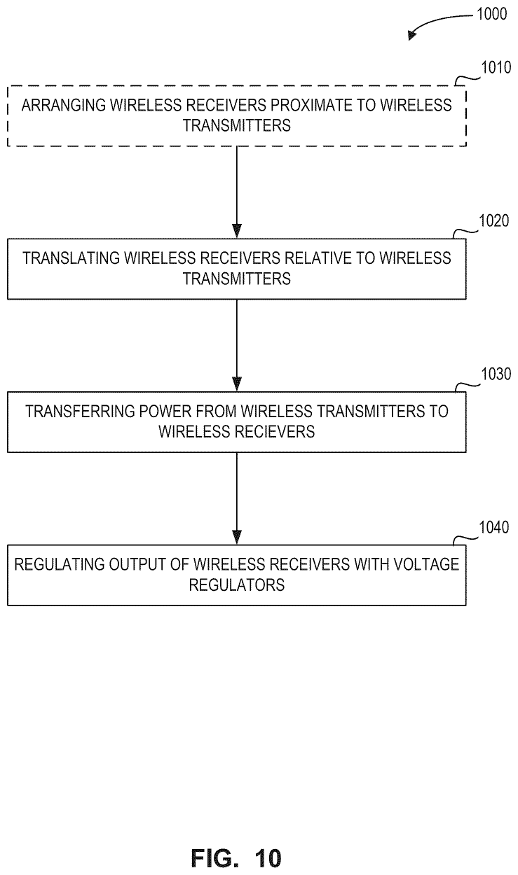

Referring now to FIG. 10, an exemplary method of wireless power transfer is shown. The method is generally identified by reference character 1000. Optionally, at block 1010 wireless receivers are arranged proximate to wireless transmitters. For example, in system 500, the transmitter assembly 410a-410m is arranged on the stator portion 120 of the housing 100 and the receiver coils 422a-422n, receiver rectifiers 426a-426n, and voltage regulator 440/voltage regulator assembly 540, 840, 940 are arranged on the rotor portion 110 of the housing 100.

At block 1020 the wireless receivers are translated relative to the wireless transmitters. The transmitter assembly 410a-410m on the stator portion 120 of the housing 100 remains stationary. The receiver coils 422a-422n, receiver rectifiers 426a-426n, and voltage regulators 440/voltage regulator assembly 540, 840, 940 on the rotor portion 110 of the housing 100 rotate relative to the stator portion 120 and the transmitter assembly 410a-410m. As the rotor portion 110 rotates, each receiver coil 422a-422noverlaps the first transmitter coil 416a and the second transmitter coil 416b.

At block 1030 power is transferred from the wireless transmitters to the wireless receivers. As each receiver coil 422a-422n overlaps a respective one of the first transmitter coil 416a and the second transmitter coil 416b, when the overlap is sufficient (e.g., 20 to 30%) power transfer from the respective transmitter coil commences. The transfer continues until each receiver coil 422a-422n has passed the respective transmitter coil such that a remaining overlap is insufficient for power transfer (e.g., less than the 20 to 30%).

At block 1040 the output from the wireless receivers is regulated with voltage regulators. The voltage regulator 440/voltage regulator assembly 540, 840, 940 equalize the voltage across the receiver coils 422a-422n. The voltage regulator 440 may be a DC-to-DC converter. The voltage regulator assemblies 540, 840, 940 may include DC-to-DC converters.

The method 1000 further includes energizing the first transmitter coil 416a and the second transmitter coil 416b simultaneously. The input conditioners 130 are used to supply the voltage initially to each of the first transmitter inverter 412a and the second transmitter inverter 412b. This allows both of the transmitters to energize almost simultaneously.

In some cases, the current through each voltage regulator 542a-542n in the voltage regulator assembly 540 is limited. A current limit may be added in the output of the voltage regulator 440 to aid in balancing.

Although the method 1000 describes the receiver coils 422a-422n as being translatable with respect to the first transmitter coil 416a and the second transmitter coil 416b, other arrangements are possible. In some cases, the first transmitter coil 416a and the second transmitter coil 416b may be translatable with respect to the receiver coils 422a-422n.

As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including”have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third”item).

A number of the drawings depict sets of elements of indeterminate length. Suffixes to the reference characters are used to indicate elements of the same type belonging to the set. For example, the reference characters 1000a, 1000b, . . . , 1000n may be used to indicate the set of elements 1000. In this context, the suffix ‘m’, ‘n’, ‘p’ or the like is used in its cardinal sense to define the number of elements in the set, but is not intended to imply any specific numerical value or values. Nor is there is any implied relationship between the alphabetical suffixes (e.g., the number represented by ‘n’ need not be greater in value than the number represented by ‘m’). Accordingly, for n=2, the expression “1000a-1000n” should be understood to mean “1000a and 1000b.” For n=5, the expression “1000a-1000n” should be understood to mean “1000a, 1000b, 1000c, 1000d and 1000e.”

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art. Although embodiments have been described above with reference to the accompanying drawings, those of skill in the art will appreciate that variations and modifications may be made without departing from the scope thereof as defined by the appended claims.

What is claimed is:

1. A system for wireless power transfer comprising:
a plurality of wireless transmitters, connectable to a power source;
a plurality of wireless receivers wherein each of the wireless receivers is configured to transiently receive power from at least one of the plurality of wireless transmitters when proximate thereto; and
a plurality of voltage regulators, each voltage regulator electrically connected to at least one of the plurality of wireless receivers.

2. The system of claim 1, wherein at least one of:
each voltage regulator is a DC to DC converter,
each voltage regulator is electrically connected to a respective wireless receiver of the plurality of wireless receivers, and
each voltage regulator is electrically connected to two or more wireless receivers of the plurality of wireless receivers, wherein each wireless receiver of the two or more wireless receivers are non-adjacent.

3. The system of claim 1, wherein each voltage regulator is electrically connected to a balancing resistor, wherein the balancing resistor is a resistor in series with each voltage regulator, and/or wherein the balancing resistor is a variable resistor controllable to optimize voltage across each voltage regulator.

4. The system of claim 1, wherein each wireless receiver of the plurality of wireless receivers comprises a coil and a rectifier, respectively, and wherein each coil includes a tuning capacitor.

5. The system of claim 1, further comprising an input conditioner electrically connected to each of the plurality of wireless transmitters and configured to energize each wireless transmitter simultaneously.

6. The system of claim 1, wherein the system is a rotary system, wherein the plurality of wireless receivers is arranged in a stator of the rotary system, and wherein the plurality of wireless transmitters is arranged in a rotor of the rotary system.

7. The system of claim 1, wherein the system is a rotary system, wherein the plurality of wireless receivers is arranged in a rotor of the rotary system, and wherein the plurality of wireless transmitters is arranged in a stator of the rotary system, and wherein the plurality of wireless transmitters is arranged equidistant from each other about the stator, and/or wherein the plurality of wireless receivers is arranged equidistant from each other around about the rotor.

8. The system of claim 7, further comprising a housing enclosing the stator and the rotor, wherein the housing is generally circular and has a first annular portion that is stationary and another portion that is rotatable relative to the first annular portion.

9. The system of claim 8, wherein each wireless receiver receives power from a respective wireless transmitter when there is an overlap between each wireless receiver and the respective wireless transmitter.

10. A method of wireless power transfer comprising:
arranging a plurality of wireless receivers proximate to a plurality of wireless transmitters;
translating the plurality of wireless receivers relative to the plurality of wireless transmitters;
transferring power from at least one of the plurality of wireless transmitters to at least one of the plurality of wireless receivers; and
regulating an output of each wireless receiver with a plurality of voltage regulators, each voltage regulator electrically connected to at least one of the plurality of wireless receivers.

11. The method of claim 10, wherein at least one of:
each voltage regulator is a DC to DC converter,
the arranging the plurality of wireless receivers proximate to the plurality of wireless transmitters comprises electrically connecting each voltage regulator to a respective wireless receiver of the plurality of wireless receivers, and
the arranging the plurality of wireless receivers proximate to the plurality of wireless transmitters comprises electrically connecting each voltage regulator to two or more wireless receivers of the plurality of wireless receivers, wherein each wireless receiver of the two or more wireless receivers are non-adjacent.

12. The method of claim 10, wherein the arranging the plurality of wireless receivers proximate to the plurality of wireless transmitters comprises electrically connecting each voltage regulator to a balancing resistor.

13. The method of claim 12, wherein the balancing resistor is a resistor in series with each voltage regulator, or wherein the method further comprises optimizing a voltage across each voltage regulator with a variable resistor.

14. The method of claim 10, wherein each wireless receiver of the plurality of wireless receivers comprises a coil and a rectifier, respectively, and wherein each coil includes a tuning capacitor.

15. The method of claim 10, further comprising:
energizing each of the plurality of wireless transmitters simultaneously with a respective input conditioner electrically connected to each of the plurality of wireless transmitters, or
limiting the current through each voltage regulator to equalize a voltage across each voltage regulator.

16. The method of claim 10, wherein the plurality of wireless receivers is arranged in a stator of a rotary system, and wherein the plurality of wireless transmitters is arranged in a rotor of the rotary system.

17. The method of claim 10, wherein the plurality of wireless receivers is arranged in a rotor of a rotary system, and wherein the plurality of wireless transmitters is arranged in a stator of the rotary system.

18. The method of claim 17, wherein at least one of:
the arranging the plurality of wireless receivers proximate to the plurality of wireless transmitters comprises arranging, the plurality of wireless transmitters equidistant from each other about the stator; and
the arranging the plurality of wireless receivers proximate to the plurality of wireless transmitters further comprises arranging the plurality of wireless receivers equidistant from each other about the rotor.

19. The method of claim 17, wherein a housing encompasses the stator and the rotor, wherein the housing is generally circular and has a first annular portion that is stationary and another portion that is rotatable relative to the first annular portion.

20. The method of claim 19, wherein the transferring power from at least one of the plurality of wireless transmitters to at least one of the plurality of wireless receivers comprises overlapping each wireless receiver and a respective wireless transmitter.
